(19) United States
(12) Patent Application Publication
(10) Pub. No.: US 2026/0116390 A1
(43) Pub. Date: Apr. 30, 2026

(54) SERVER SYSTEM

(71) Applicant: TOYOTA JIDOSHA KABUSHIKI KAISHA, Toyota-shi (JP)

(72) Inventor: Hironobu KITAOKA, Nisshin-shi (JP)

(73) Assignee: TOYOTA JIDOSHA KABUSHIKI KAISHA, Toyota-shi (JP)

(21) Appl. No.: 19/354,113

(22) Filed: Oct. 9, 2025

(30) Foreign Application Priority Data
Oct. 25, 2024 (JP) 2024-188485

(51) Int. Cl. B60W 40/04; B60W 30/09; G08G 1/052; G08G 1/16

(52) U.S. Cl. CPC B60W 40/04; B60W 30/09; G08G 1/052; G08G 1/164; G08G 1/166; B60W 2554/4042; B60W 2554/406; B60W 2554/408; B60W 2556/45

(57) ABSTRACT

A server system includes an acquisition unit for acquiring first information indicating traffic characteristics in a predetermined section on a road, an estimation unit for estimating a propagation speed of a wave of deceleration that is propagated in the predetermined section, based on the first information, and a control unit for controlling a vehicle using second information based on the propagation speed that is estimated.

### CROSS-REFERENCE TO RELATED APPLICATION

This application claims priority to Japanese Patent Application No. 2024-188485 filed on Oct. 25, 2024. The disclosure of the above-identified application, including the specification, drawings, and claims, is incorporated by reference herein in its entirety.

### BACKGROUND

### 1. Technical Field

The present disclosure relates to the technical field of a server system.

### 2. Description of Related Art

One such system that is proposed sets driving control parameters including speed, inter-vehicle distance, and time headway, when a vehicle is traveling in an automated driving mode that automatically controls traveling of the vehicle, based on traffic information including average speed, average time headway, average inter-vehicle distance, and traffic density of vehicles at a point near the vehicle (see Japanese Unexamined Patent Application Publication No. 2016-200931 (JP 2016-200931 A)).

### SUMMARY

When a road is relatively congested, for example, and one vehicle traveling ahead of and also at a position relatively far away from an own vehicle, slows down, a following vehicle traveling behind this one vehicle will also slow down. This causes a speed reduction phenomenon that is propagated rearward from the one vehicle. As a result, there is a possibility that the speed reduction phenomenon will propagate to the own vehicle as well. When such a phenomenon occurs, the likelihood of a rear-end collision increases. With the technology that is described in JP 2016-200931 A, it is difficult to detect the propagation of the speed reduction phenomenon such as described above. Note that technology has been proposed that uses artificial intelligence (AI) to measure traffic volume from images.

The present disclosure has been made in light of the above circumstances, and an object thereof is to provide a server system that can detect propagation of a speed reduction phenomenon.

A server system according to an aspect of the present disclosure includes an acquisition unit for acquiring first information indicating traffic characteristics in a predetermined section on a road, an estimation unit for estimating a propagation speed of a wave of deceleration that is propagated in the predetermined section, based on the first information, and a control unit for controlling a vehicle using second information based on the propagation speed that is estimated.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of a server system according to an embodiment;

FIG. 2 is a diagram showing an example of traffic characteristics expressed by traffic flow rate and density; and

FIG. 3 is a diagram showing an example of a path of travel of a vehicle.

### DETAILED DESCRIPTION OF EMBODIMENTS

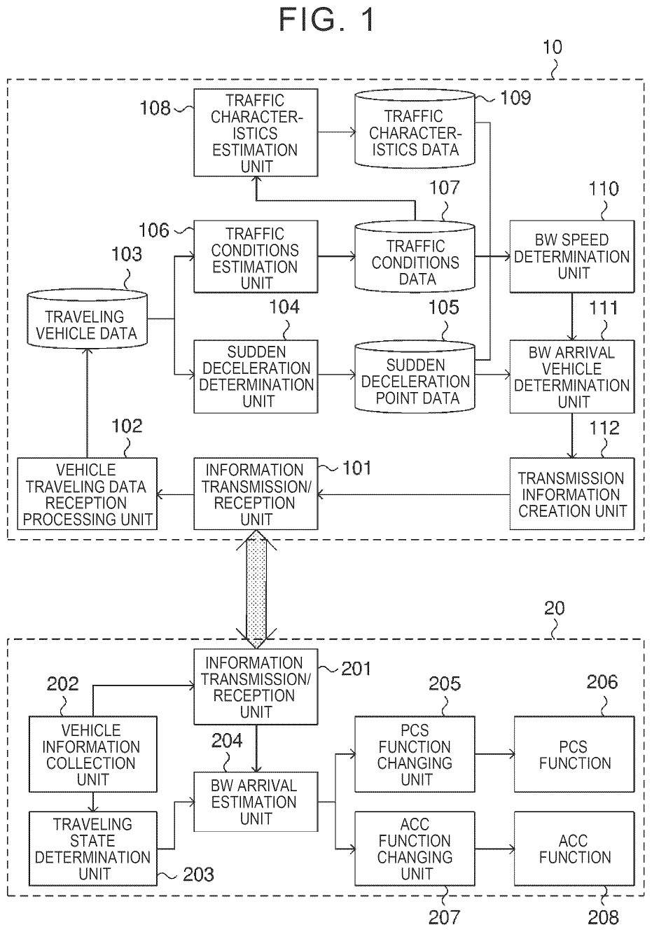

An embodiment of a server system will be described with reference to FIGS. 1 to 3. In FIG. 1, the server system 10 includes an information transmission/reception unit 101, a vehicle traveling data reception processing unit 102, a sudden deceleration determination unit 104, a traffic conditions estimation unit 106, a traffic characteristics estimation unit 108, a backward wave speed determination unit 110, a backward wave arrival vehicle determination unit 111, and a transmission information creation unit 112. Hereinafter, the “backward wave speed determination unit 110” and the “backward wave arrival vehicle determination unit 111” will be referred to as “BW speed determination unit 110” and “BW arrival vehicle determination unit 111”, respectively.

The information transmission/reception unit 101 is configured to be capable of communication with a vehicle 20. The information transmission/reception unit 101 receives traveling data from the vehicle 20. For example, traveling data may include at least one of position of the vehicle 20, speed of the vehicle 20, inter-vehicle distance from the vehicle 20 to a vehicle traveling ahead of vehicle 20, information indicating that a braking operation has been performed, and operation information of a driver assistance function. Note that the driver assistance function may include at least one of a collision damage mitigation braking system (Pre-Crash Safety (PCS) system), an adaptive cruise control (ACC) system, and an anti-lock braking system (ABS).

The vehicle traveling data reception processing unit 102 subjects the traveling data that is received by the information transmission/reception unit 101 to predetermined processing. For example, the vehicle traveling data reception processing unit 102 may perform processing for converting the traveling data into a format that is suitable for a database, as the predetermined processing. The vehicle traveling data reception processing unit 102 registers the traveling data in a database 103.

The sudden deceleration determination unit 104 determines, based on the traveling data that is registered in the database 103, whether there is a vehicle that has performed sudden deceleration. For example, the sudden deceleration determination unit 104 may determine whether there is a vehicle that has performed sudden deceleration, based on at least one of change in speed, whether a braking operation has been performed, and operation information of the driver assistance function, regarding a vehicle (e.g., vehicle 20). When determination is made that there is a vehicle that has performed sudden deceleration, the sudden deceleration determination unit 104 may identify the spot at which the sudden deceleration was performed, based on the position of the vehicle that is included in the traveling data. The sudden deceleration determination unit 104 then registers, in a database 105, point data indicating the point at which the sudden deceleration was performed, and a time at which the sudden deceleration was performed.

The traffic conditions estimation unit 106 extracts traveling data relating to a plurality of vehicles that have traveled in a predetermined section during a predetermined time period, from the traveling data that is registered in the database 103. The traffic conditions estimation unit 106 estimates traffic conditions in the predetermined section during the predetermined time period, based on the traveling data that is extracted. The traffic conditions estimation unit 106 registers traffic conditions data indicating estimation results in a database 107. For example, the traffic conditions estimation unit 106 may estimate density and traffic flow rate as the traffic conditions. Here, the density may be calculated as the reciprocal of a distance (in other words, a length) that is occupied by one vehicle. The distance that is occupied by one vehicle may be the sum of the vehicle length of the vehicle and the inter-vehicle distance thereof. Traffic flow rate may be calculated as the product of density and vehicle speed. Note that the vehicle speed of the vehicle may be an average speed of a plurality of vehicles traveling in a predetermined section. Note that at least one of the predetermined section and the predetermined time period may be specified in advance by an operator of the server system 10. Note that the predetermined section may be a part of a motorway (e.g., an expressway).

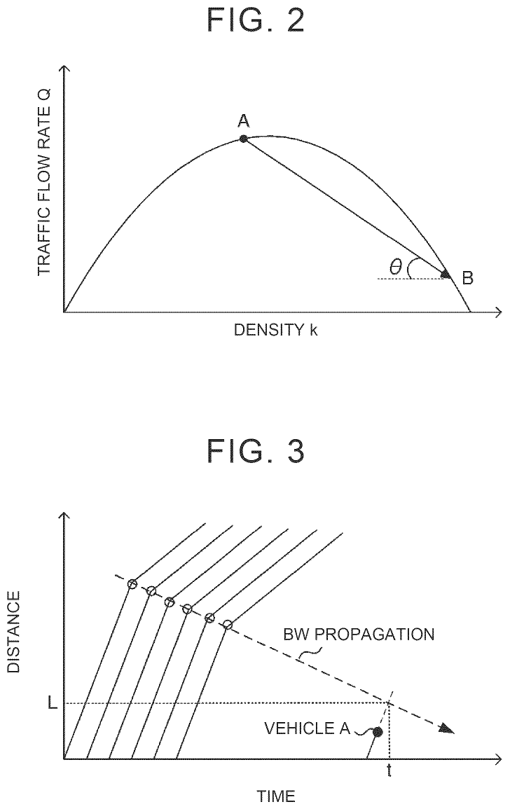

The traffic characteristics estimation unit 108 estimates traffic characteristics of a predetermined section for a predetermined time period, based on the traffic conditions data that is registered in the database 107. Here, the traffic characteristics can be expressed by a k-Q curve as shown in FIG. 2. For example, the traffic characteristics estimation unit 108 may estimate the k-Q curve as the aforementioned traffic characteristics based on traffic conditions data. The traffic characteristics estimation unit 108 registers traffic conditions data indicating the estimation results in a database 109. Note that in the k-Q curve, a traffic flow in a state in which the density k is relatively low may be referred to as “free flow”. In the k-Q curve, a traffic flow in a state in which the density k is higher than the density of the free flow, and also the traffic flow rate Q is higher than the traffic flow in free flow may be referred to as “critical flow”. In the k-Q curve, a traffic flow in a state in which the density k is higher than the density of the critical flow may be referred to as a “congested traffic flow”.

The BW speed determination unit 110 may determine, based on the point data that is registered in the database 105, whether there is a point at which the sudden deceleration was performed within a predetermined time period. When determination is made that there is a point at which the sudden deceleration was performed within the predetermined time period, the BW speed determination unit 110 acquires traffic conditions data and traffic characteristics data, regarding a section including the point at which the sudden deceleration was performed and also a time period including a time at which the sudden deceleration was performed, from databases 107 and 109.

The BW speed determination unit 110 determines a propagation speed of a backward wave based on the traffic conditions data and the traffic characteristics data. Here, the backward wave is an expression describing a phenomenon in which, when following vehicles are traveling while following movement of a vehicle traveling ahead, the change in speed of the vehicle traveling ahead is propagated to the following vehicles, one after another, as a wave phenomenon. For example, when the vehicle traveling ahead performs sudden deceleration, the speed reduction phenomenon is propagated to the following vehicles, one after another. Note that the backward wave may also be referred to as “shock wave”.

For example, the BW speed determination unit 110 may identify a difference between the traffic conditions in the section where the sudden deceleration occurred, at the time period in which the sudden deceleration occurred, and the traffic conditions in the time period immediately preceding the time period in which the sudden deceleration occurred. When sudden deceleration occurs, the inter-vehicle distance decreases. Accordingly, the density during the time period in which the sudden deceleration occurred is higher than the density during the time period prior to the time period in which the sudden deceleration occurred. For example, in the k-Q curve shown in FIG. 2, when the traffic conditions in the time period before the time period in which sudden deceleration occurs are the traffic conditions corresponding to point A, and the traffic conditions in the time period in which sudden deceleration occurred are the traffic conditions corresponding to point B, the propagation speed of the backward wave can be determined from an inclination θ of a line segment connecting points A and B. For example, the BW speed determination unit 110 may determine the propagation speed of the backward wave, from the difference that is identified, and the k-Q curve.

For example, the BW speed determination unit 110 may identify the difference between the traffic conditions in the section where the sudden deceleration occurred and the traffic conditions in the section downstream of the section. Note that the section downstream of the section where sudden deceleration occurred means a section ahead of the section in which the vehicle that suddenly decelerated is located, in a traveling direction of the vehicle. The traffic conditions in the section downstream of the section where the sudden deceleration occurred can be said to be the traffic conditions in the section where the sudden deceleration occurred before the sudden deceleration occurred. Accordingly, the BW speed determination unit 110 may determine the propagation speed of the backward wave, from the difference that is identified, and the k-Q curve.

For example, the BW speed determination unit 110 may aggregate sudden decelerations that are caused by the same backward wave from past statistical data for each section of the road, such as point data, traffic conditions data, and so forth, and calculate the propagation speed of the backward wave in advance. The BW speed determination unit 110 may then record, in advance, a relation between the k-Q curve, which is an example of traffic characteristics data, and the propagation speed of the backward wave. For example, the BW speed determination unit 110 may determine the propagation speed of the backward wave based on the traffic conditions in the section in which the sudden deceleration occurred this time, and the above relation that is recorded in advance.

Assuming that the speed change of the vehicle traveling ahead is propagated to the following vehicles one after another, when one vehicle performs sudden deceleration, the vehicles following the one vehicle also perform sudden deceleration. For example, the BW speed determination unit 110 may extract, from a plurality of pieces of point data, one or more pieces of point data related to sudden deceleration that is caused by the same backward wave. The BW speed determination unit 110 may then determine the propagation speed of the backward wave, based on the point at which the sudden deceleration was performed, and the time at which the sudden deceleration was performed, which are indicated by the point data that is extracted.

For example, the BW speed determination unit 110 may use a trained model (in other words, AI) to determine the propagation speed of the backward wave. Note that the trained model may be a trained model that is constructed by machine learning, using data for each section on a road (e.g., point data, traffic conditions data, and traffic characteristics data), and so forth, as training data.

The BW arrival vehicle determination unit 111 identifies a vehicle upstream of the point at which the sudden deceleration occurred, and to which the backward wave is estimated to be propagated in the future, based on the point data that is registered in the database 105 and the propagation speed of the backward wave that is determined by the BW speed determination unit 110. The BW arrival vehicle determination unit 111 then determines (or estimates) the position and time at which the vehicle that is identified will encounter the backward wave. Note that the expression “upstream of the point at which the sudden deceleration occurred” means rearward from the vehicle that suddenly decelerated in the traveling direction.

Further explanation will now be given with reference to a time-space diagram shown in FIG. 3. In FIG. 3, open circles indicate points where sudden deceleration has occurred. In FIG. 3, inclination of a dashed arrow indicating the backward wave changes in accordance with the propagation speed of the backward wave. In FIG. 3, a filled circle indicates the current position of a vehicle A. A solid line extending from the filled circle corresponds to a past path of travel of the vehicle A, and a dashed line extending from the filled circle corresponds to a future path of travel of vehicle A. In FIG. 3, an intersection point (time t, distance L) of the dashed line extending from the filled circle indicating the current position of the vehicle A and the dashed arrow indicating the backward wave corresponds to the position and the time at which the vehicle A will encounter the backward wave, as determined by the BW arrival vehicle determination unit 111.

The transmission information creation unit 112 creates transmission information to be transmitted to the vehicle that is identified by the BW arrival vehicle determination unit 111, to which the backward wave will be propagated in the future. For example, the transmission information may be at least one of information for alerting a driver of the vehicle, and information for changing parameters related to the driver assistance function. An example of information for alerting the driver is information that notifies the driver of a situation in which rear-end collisions occur more readily. Examples of parameters related to the driver assistance functions include parameters for advancing the timing at which the collision damage mitigation braking system issues a rear-end collision warning (specifically, parameters related to at least one of inter-vehicle distance and relative speed at which the rear-end collision warning is issued), parameters for advancing the timing at which the collision damage mitigation braking system starts control to increase the brake pressure, parameters for temporarily increasing the inter-vehicle distance that is set in the adaptive cruise control, and so forth.

The information transmission/reception unit 101 transmits the transmission information that is created by the transmission information creation unit 112 to a vehicle (e.g., vehicle 20).

The vehicle 20 is equipped with an information transmission/reception unit 201, a vehicle information collection unit 202, a traveling state determination unit 203, a backward wave arrival estimation unit 204, a PCS function changing unit 205, a PCS function 206, an ACC function change unit 207 and an ACC function 208. Hereinafter, the “backward wave arrival estimation unit 204” will be referred to as “BW arrival estimation unit 204” as appropriate. Note that the PCS function 206 may be rephrased as “collision damage mitigation braking system”. Note that the vehicle 20 may be a connected car.

The vehicle information collection unit 202 may acquire information from various types of sensors that are installed in the vehicle 20. The vehicle information collection unit 202 may transmit the information that is acquired to the server system 10 as traveling data, via the information transmission/reception unit 201, at predetermined intervals. The traveling state determination unit 203 may determine a traveling state of the vehicle 20, based on the information from the various types of sensors that is acquired by the vehicle information collection unit 202.

The BW arrival estimation unit 204 may estimate the timing at which the backward wave will reach the vehicle 20, based on the transmission information (i.e., transmission information created by the transmission information creation unit 112) that is received from the server system 10 via the information transmission/reception unit 201, and the traveling state of the vehicle 20 that is determined by the traveling state determination unit 203 (e.g., position and speed of vehicle 20). When the transmitted information is information for alerting the driver, the BW arrival estimation unit 204 may issue an alert to the driver in accordance with the timing that is estimated. When the transmission information is information for changing parameters related to the driver assistance function, the BW arrival estimation unit 204 may change the parameters related to the driver assistance function in accordance with the timing that is estimated. When the parameters to be changed are parameters related to the collision damage mitigation braking system (PCS), the BW arrival estimation unit 204 may control the PCS function changing unit 205 to change parameters related to the PCS function 206. When the parameters to be changed are parameters related to adaptive cruise control, the BW arrival estimation unit 204 may control the ACC function changing unit 207 to change parameters related to the ACC function 208.

Note that the server system 10 may be made up of a single server, or may be made up of a plurality of servers. The vehicles that the BW arrival vehicle determination unit 111 has identified to be vehicles to which the backward wave is estimated to be propagated, are not limited to vehicles traveling in a section including the point in which the sudden deceleration occurred, and may also be vehicles traveling in a section other than the section including the point at which the sudden deceleration occurred.

### Technical Effect

In a situation in which following vehicles are traveling while following movement of a vehicle traveling ahead, and the speed of the vehicle traveling ahead decreases due to deceleration, the decrease in speed is propagated to the following vehicles one after another. It is known that in a critical flow (i.e., speed and density at which maximum traffic volume is realized on a given road section), rear-end collisions are likely to occur due to reduction in speed. Here, backward propagation of deceleration that causes rear-end collisions (in other words, propagation of speed reduction phenomenon) differs depending on the traffic characteristics of the road section. For example, different propagation speeds may occur depending on the traffic characteristics. Also, depending on the traffic characteristics, sudden deceleration of one vehicle may not be propagated to the following vehicles.

The server system 10 determines (or estimates) the propagation speed of the backward wave. The server system 10 identifies a vehicle to which the backward wave will propagate in the future. The server system 10 transmits, to the vehicle that is identified, at least one of information for alerting the driver of the vehicle and information for changing parameters related to the driver assistance function, for example. As a result, in the vehicle, the driver may be alerted, parameters related to the driver assistance function may be changed, and so forth. In this way, the server system 10 can detect propagation of the speed reduction phenomenon and also can suppress rear-end collisions from occurring.

Various aspects of the disclosure, derived from the embodiment described above, will be described below.

A server system according to an aspect of the present disclosure includes an acquisition unit for acquiring first information indicating traffic characteristics in a predetermined section on a road, an estimation unit for estimating a propagation speed of a wave of deceleration that is propagated in the predetermined section, based on the first information, and a control unit for controlling a vehicle using second information based on the propagation speed that is estimated. In the above-described embodiment, the “traffic characteristics estimation unit 108” corresponds to an example of “acquisition unit”, the “BW speed determination unit 110” corresponds to an example of “estimation unit”, and the “transmission information creation unit 112” corresponds to an example of “control unit”.

In one example of the server system, the first information may include at least one of a vehicle density and a traffic flow rate in the predetermined section.

In another example of the server system, the second information may be information indicating at least one of a position and a time at which the wave of deceleration that is propagated will reach the vehicle.

In another example of the server system, the control unit may control the vehicle by changing parameters related to a driver assistance function that is provided in the vehicle.

In another example of the server system, the estimation unit may estimate the propagation speed using a trained model that is constructed by machine learning.

The present disclosure is not limited to the above-described embodiment, and can be modified as appropriate without departing from the gist or spirit of the disclosure that can be read from the claims and the entire specification, and a server system including such modifications is also included in the technical scope of the present disclosure.

What is claimed is:

1. A server system, comprising:
an acquisition unit for acquiring first information indicating traffic characteristics in a predetermined section on a road;
an estimation unit for estimating a propagation speed of a wave of deceleration that is propagated in the predetermined section, based on the first information; and
a control unit for controlling a vehicle using second information based on the propagation speed that is estimated.

2. The server system according to claim 1, wherein the first information includes at least one of a vehicle density and a traffic flow rate in the predetermined section.

3. The server system according to claim 1, wherein the second information is information indicating at least one of a position and a time at which the wave of deceleration that is propagated will reach the vehicle.

4. The server system according to claim 1, wherein the control unit controls the vehicle by changing parameters related to a driver assistance function that is provided in the vehicle.

5. The server system according to claim 1, wherein the estimation unit estimates the propagation speed using a trained model that is constructed by machine learning.
